(19) United States
(12) Patent Application Publication
(10) Pub. No.: US 2012/0043809 A1
(43) Pub. Date: Feb. 23, 2012

(54) Auxiliary Device Using Primary Inverter Feeds

(75) Inventor: Alex Creviston, Muncie, IN (US)

(73) Assignee: REMY TECHNOLOGIES, L.L.C., Pendleton, IN (US)

(21) Appl. No.: 12/858,916

(22) Filed: Aug. 18, 2010

(51) Int. Cl. B60L 1/00; H02M 1/12

(52) U.S. Cl. 307/10.1; 307/105

(57) ABSTRACT

An electric machine system includes an electric motor, an auxiliary device configured to receive filtered electric power, and a filter. The filter is configured to receive electric power and to pass filtered electric power to the auxiliary device at a frequency not used for power conversion to rotational energy by the electric motor. A method for operating the electric machine system is also disclosed.

### BACKGROUND

Exemplary embodiments pertain to the art of electric machines and, more particularly, to an auxiliary device coupled to a power feed for an electric machine.

Electric vehicles (EVs) or hybrid electric vehicles (HEVs) are gaining in popularity as fuel prices increase and consumers have greater awareness of environmental impacts caused by traditional vehicles. Both EVs and HEVs use a traction motor powered by electricity for propulsion to reduce emissions.

High power traction motors and the electronics, such as inverters, that provide electrical power and control generally require liquid cooling to meet most application packaging requirements. The cooling systems are typically separate from the cooling systems for the internal combustion engines in hybrid electric vehicles (HEVs) due to lower coolant temperature needs. In pure electric vehicles (EVs), liquid cooling systems for the traction motors and electronics are the only cooling system in the vehicles. The liquid cooling systems generally require a prime mover to provide fluid pressure and flow to circulate the coolant through the various components in the circuit. The prime mover and associated components add cost and complexity as well as increased system energy requirements. Improving fraction motor efficiency is one path toward enhanced operational efficiency of EVs and HEVs.

### BRIEF DESCRIPTION

Disclosed is an electric machine system including an electric motor, an auxiliary device configured to receive filtered electric power, and a filter. The filter is configured to receive electric power and to pass filtered electric power to the auxiliary device at a frequency not used for power conversion to rotational energy by the electric motor.

Also disclosed is an electric machine system including: a vehicle; a traction motor configured to propel the vehicle; an auxiliary device configured to receive filtered electric power; and a filter configured to receive electric power and to pass filtered electric power to the auxiliary device at a frequency not used for power conversion to rotational energy by the traction motor.

Further disclosed is a method of operating an electric machine system having an electric motor, the method includes: receiving electric power; and filtering the received electric power to pass filtered electric power to an auxiliary device at a frequency not used for power conversion to rotational energy by the electric motor.

### BRIEF DESCRIPTION OF THE DRAWINGS

The following descriptions should not be considered limiting in any way. With reference to the accompanying drawings, like elements are numbered alike:

FIG. 1 depicts a vehicle having a traction motor, an inverter powering the traction motor, a filter, and an auxiliary device;

FIG. 2 depicts aspects of the filter configured to block electric power to the traction motor at frequencies not used for power conversion by the traction motor;

FIG. 3 depicts aspects of the filter coupled to three solenoid pumps;

FIG. 4 depicts aspects of the filter coupled to electric motor windings; and

FIG. 5 presents one example of a method for operating an electric machine system having the fraction motor and the auxiliary device.

### DETAILED DESCRIPTION

A detailed description of one or more embodiments of the disclosed apparatus and method are presented herein by way of exemplification and not limitation with reference to the Figures.

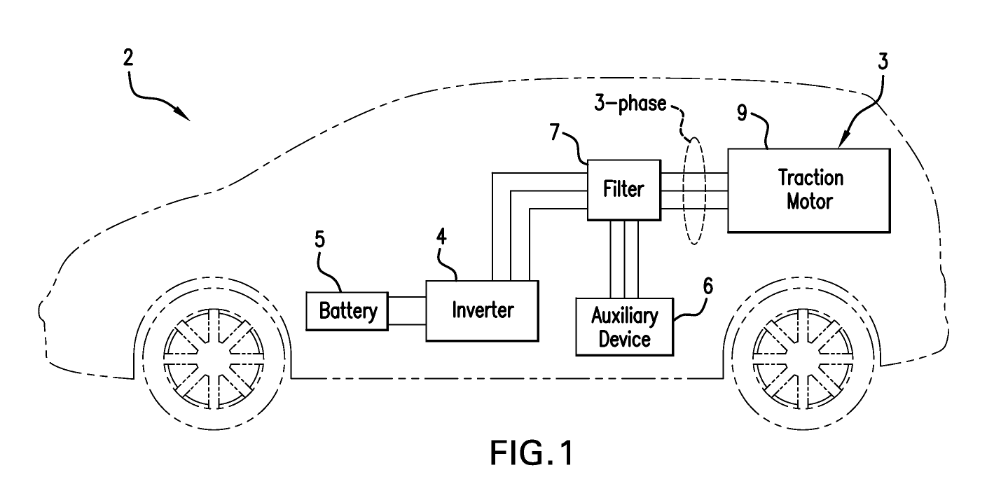

An electric machine system in accordance with an exemplary embodiment is indicated generally at 2 in FIG. 1. In the embodiment of FIG. 1, the electric machine system 2 is a vehicle such as an EV or an HEV. Electric machine system 2 includes an electric machine, shown in the form of a traction motor or electric motor 3. The electric motor 3 is powered by an inverter 4, such as a variable speed motor drive, which varies motor speed by varying an output frequency. The inverter 4 receives electric power from a direct current (DC) source such as a battery 5.

The electric machine system 2 includes an auxiliary device 6, which is also powered by the inverter 4. In one embodiment, the auxiliary device 6 is configured to perform useful work such as mechanical work. A filter 7 is coupled to an output of the inverter 4 and filters the electric power provided to the auxiliary device 6. The filter 7 allows power to pass that is of a frequency that is not used or detrimental to the electric motor 3. For example, the electric motor 3 is generally powered by alternating current (AC) having a fundamental frequency. Higher order frequencies, such as the third or fifth harmonic, are normally dissipated as heat in an electromagnetic circuit or windings in the electric motor 3. Hence, an advantage of the electric motor 3 is that power normally wasted can be used to perform useful work by the auxiliary device 6 and, thus, increase the overall efficiency of the electric machine system 2. Another advantage is additional heat will not be dissipated in the electric motor 3 resulting in prolonging the life of the electric motor 3. Alternatively, the auxiliary device 6 can be a heat sink to which the normally wasted power is directed. Thus, with the auxiliary device 6 as a heat sink, the overall efficiency of the system 2 may not increase, however, the reliability and life of the electric motor 3 will increase.

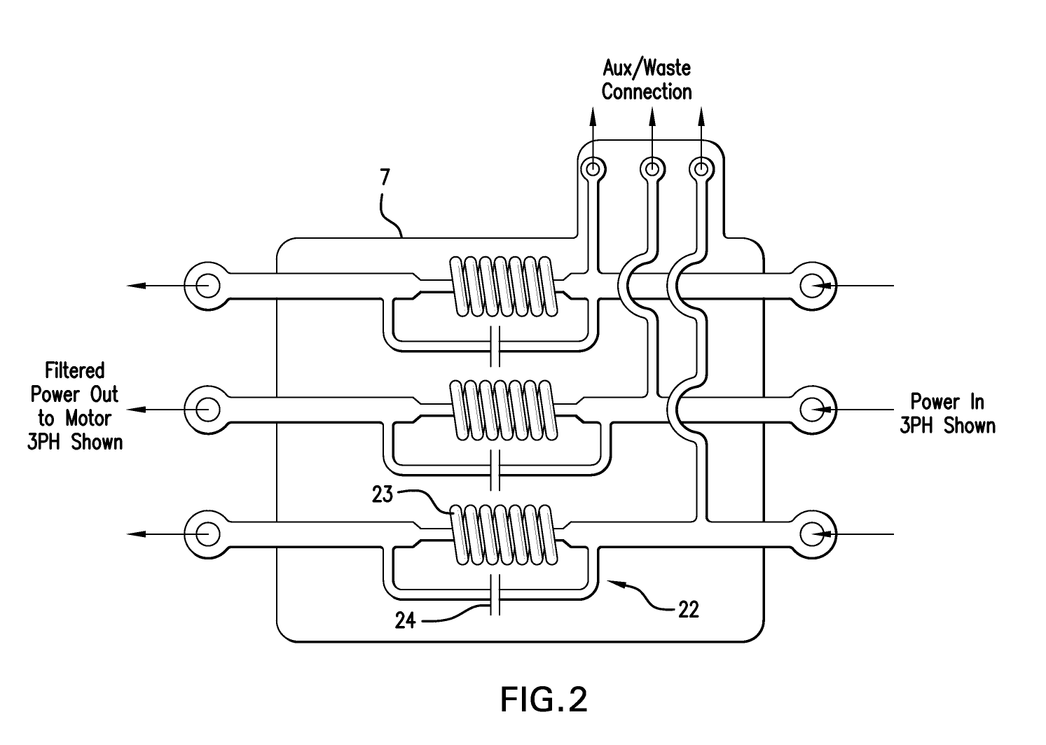

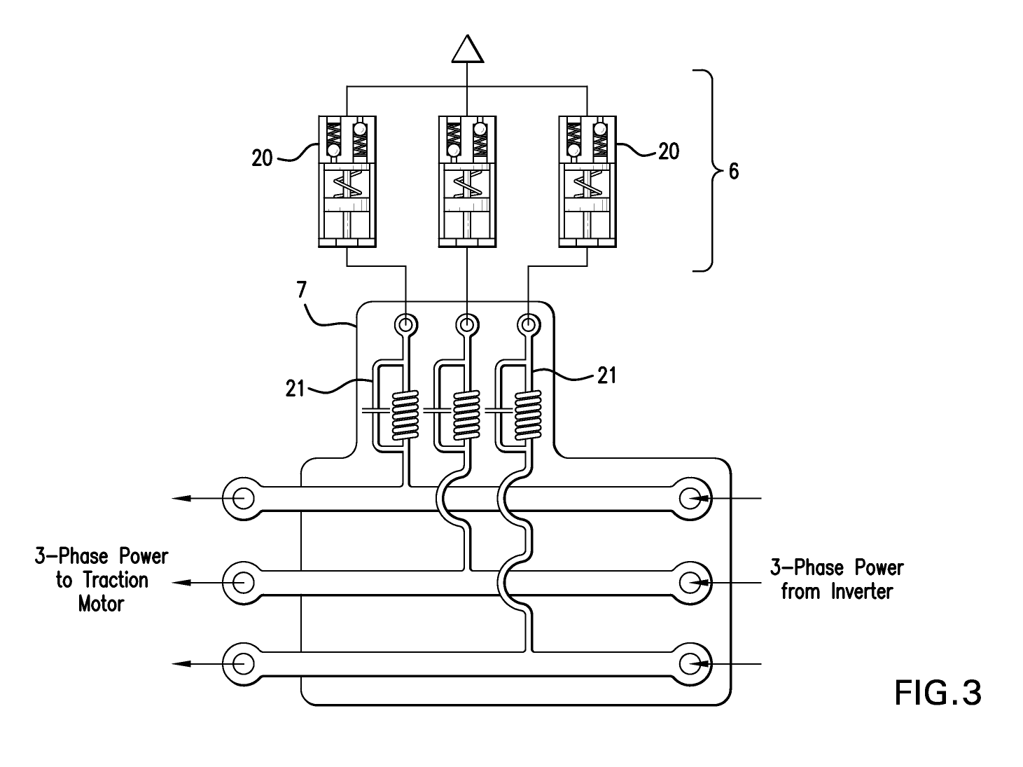

In addition to passing power that is not useful to the electric motor 3 to the auxiliary device 6, the filter 7 can also be configured to block that power to the electric motor 3. In some embodiments of the electric motor 3, though, the motor windings have enough inductance to block power at the unusable frequencies. As shown in FIG. 3, each phase of the filter 7 includes a blocking circuit 22. In the embodiment of FIG. 2, the blocking circuit 22 includes an inductor 23 in parallel with a capacitor 24 to form an LC circuit. In another embodiment, active electrical components may also be used in the blocking circuit 22.

The filter 7 can be configured to pass high frequencies, low frequencies, a selected band of frequencies, or combination thereof. In one embodiment, higher order frequencies are passed to the auxiliary device 6 and fundamental drive frequencies used by the electric motor 3 are blocked to the auxiliary device 6. In general, the fundamental drive frequencies required to drive the electric motor 3 are determined. The filter 7 is then configured to restrict (i.e., filter out) those determined fundamental drive frequencies from passing to the auxiliary device 6. Power at the passed frequencies can then be used to power the auxiliary device 6.

In one embodiment, the filter 7 includes a tank circuit or tracking filter. The filter 7 can include a passive filter circuit having frequency dependent components such as capacitors and/or inductors, an active filter circuit that includes active electronic components, or a combination thereof.

In one embodiment, the auxiliary device 6 is an electrically driven pump configured to circulate cooling fluid to cool one or more components in the electric machine system 2. Non-limiting examples of components requiring cooling include the electric motor 3, the inverter 4, and/or an internal combustion engine driving a generator for providing power to the inverter 4. The electrically driven pump may include an induction motor, an electric solenoid, and/or an AC/DC combination electric motor. The advantage of the AC/DC combination electric motor is that if the fundamental frequency to drive the electric motor 3 is DC or very low, the AC/DC combination electric motor can still operate.

In one embodiment, the electrically driven pump can be disposed inside a motor housing 9 that houses the electric motor 3 as shown in FIG. 1. The purpose of the interior pump is to pump cooling and/or lubricating fluid around the interior of the motor housing 9 or around an exterior heat rejection loop. The filter 7 may also be disposed inside the motor housing 9 so that electrical power to the filter 7 and thus to the interior pump may be received directly from the input leads of the main high voltage connections to the electric motor 3. An interior pump eliminates multiple exterior fluid and electrical connections in the total motor-cooling system and greatly reduces chances for leaks and contamination.

The power required to run a small interior pump system will generally be less than running an external pumping system due to lower total pumping and flow losses and the use of three-phase high voltage instead of typical low voltage DC. An interior pumping system also allows for greater flexibility in design for coolant flow and distribution.

Reference may now be had to FIG. 3 illustrating a plurality of solenoid-operated pumps 20 coupled to the filter 7. The solenoid-operated pumps 20 are supplied electric power at harmonic frequencies that are of no use to or that even may be detrimental to the electric motor 3. In the embodiment of FIG. 3, the filter 7 includes one LC-circuit 21 (i.e. network having capacitors and inductors) configured as a passing circuit for each solenoid-operated pump 20. Each LC-circuit 21 is powered from one phase of a three-phase electrical power output of the inverter 4.

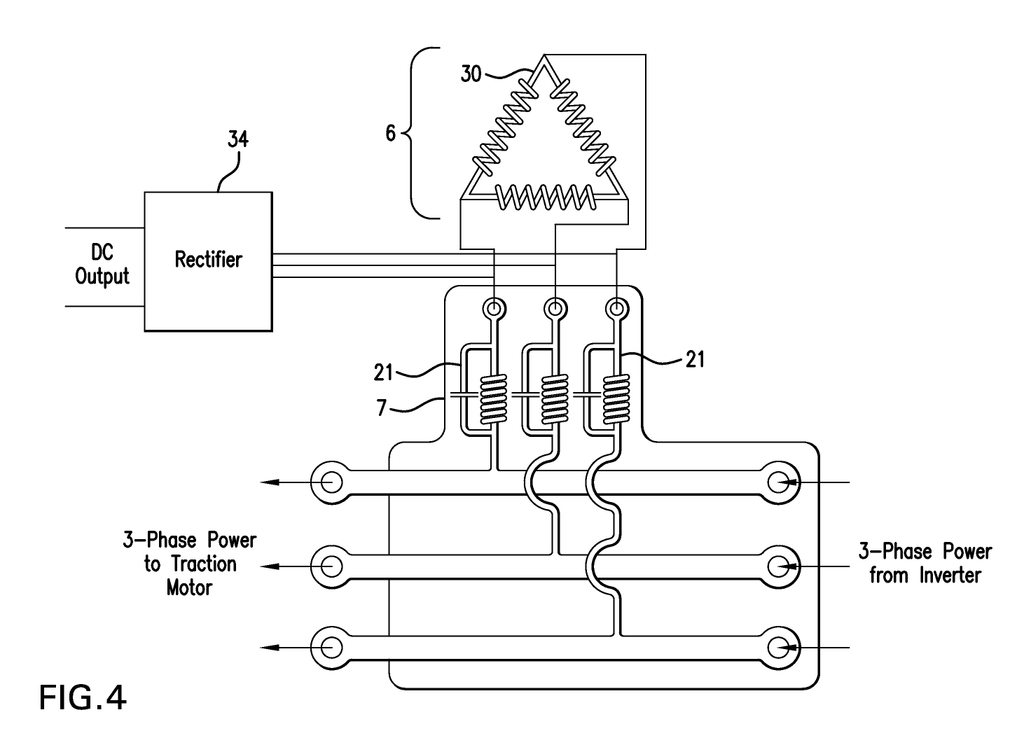

Reference may now be had to FIG. 4 illustrating the filter 7 providing electrical power to three-phase windings 30 of the auxiliary device 6 that is a three-phase motor. In the embodiment of FIG. 4, the three-phase windings 30 are in a delta-configuration. It can be appreciated that the three-phase windings 30 can also be in other configurations such as a Y-configuration.

The auxiliary device 6 can also assume other configurations. In one embodiment, the auxiliary device 6 is a heater element configured to heat a passenger cabin of a vehicle.

It can be appreciated that a rectifier 34 as shown in FIG. 4 can be used to rectify the output of the filter 7. The rectified output of the filter 7 can be used to power the auxiliary device 6 with DC power. In one embodiment, the auxiliary device 6 is a Peltier thermocouple that is powered by DC power. The Peltier couple is used for cooling purposes such as cooling a beverage cooler for example.

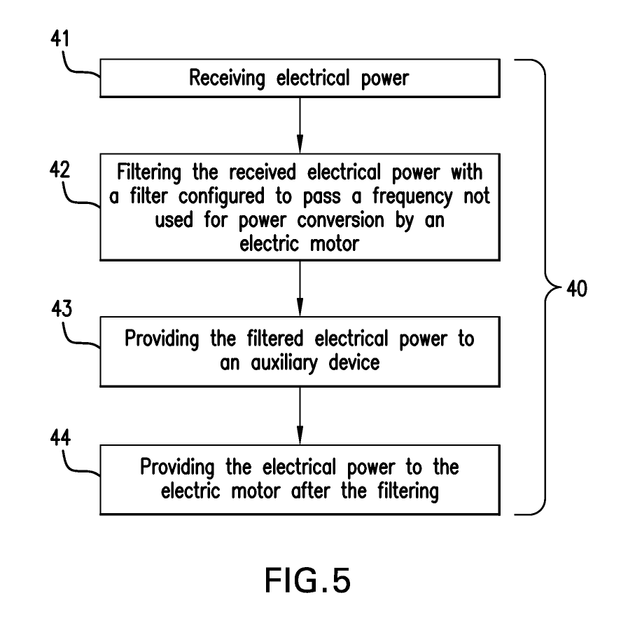

FIG. 5 presents one example of a method 40 for operating the electric machine system 2. The method 40 calls for (step 41) receiving electrical power. Further, the method 40 calls for (step 42) filtering the received electrical power with a filter configured to pass a frequency not used for power conversion by an electric motor. The term “a frequency” can include multiple frequencies including zero Hertz (DC). Further, the method 40 calls for (step 43) providing the filtered electrical power to an auxiliary device. Further, the method 40 calls for (step 44) providing the electrical power to the electric motor after the filtering. The method 40 can also include filtering the received electric power to block power at frequencies not used for power conversion from passing to the electric motor.

Elements of the embodiments have been introduced with either the articles “a” or “an.” The articles are intended to mean that there are one or more of the elements. The terms “including” and “having” are intended to be inclusive such that there may be additional elements other than the elements listed. The conjunction “or” when used with a list of at least two terms is intended to mean any term or combination of terms. The term “couple” relates to one component being coupled either directly to another component or indirectly to the another component via one or more intermediate components.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed:

1. An electric machine system comprising:
an electric motor;
an auxiliary device configured to receive filtered electric power; and
a filter electrically connected to the electric motor and the auxiliary device and configured to receive electric power and to pass filtered electric power to the auxiliary device at a frequency not used for power conversion to rotational energy by the electric motor.

2. The electric machine system according to claim 1, wherein the filter is further configured to block electric power to the electric motor at frequencies not used for power conversion to rotational energy by the electric motor.

3. The electric machine system according to claim 1, wherein the filter comprises passive electrical components.

4. The electric machine system according to claim 3, wherein the filter comprises active electrical components.

5. The electric machine system according to claim 4, wherein the filter is configured to pass the filtered electrical power in a band of frequencies.

6. The electric machine system according to claim 1, wherein the frequency not used for power conversion to rotational energy is at least one of a third harmonic and a fifth harmonic of a fundamental frequency used to power the electrical motor.

7. The electric machine system according to claim 1, wherein the filter is configured to pass electric power to the electric motor at substantially fundamental drive frequencies.

8. The electric machine system according to claim 1, further comprising an electric power source.

9. The electric machine system according to claim 8, wherein the electric power source comprises a variable frequency inverter configured to power the electric motor.

10. The electric machine system according to claim 8, wherein the electric motor is directly coupled to the electric power source.

11. The electric machine system according to claim 1, wherein the auxiliary device is an electrically powered pump.

12. The electric machine system according to claim 11, wherein the pump is disposed in a housing of the electric motor.

13. The electric machine system according to claim 1, wherein the auxiliary device is a combination AC/DC electric motor.

14. The electric machine system according to claim 1, wherein the auxiliary device is a rectifier configured to rectify the filtered electric power to provide a source of DC power.

15. The electric machine system according to claim 14, further comprising a Peltier thermoelectric couple coupled to the source of DC power.

16. The electric machine system according to claim 1, wherein the auxiliary device is a heat sink.

17. An electric machine system comprising:
a vehicle;
a traction motor configured to propel the vehicle;
an auxiliary device configured to receive filtered electric power; and
a filter configured to receive electric power and to pass filtered electric power to the auxiliary device at a frequency not used for power conversion to rotational energy by the traction motor.

18. The electric machine system according to claim 17, wherein the auxiliary device comprises a heater configured to heat a passenger cabin in the vehicle.

19. A method of operating an electric machine system comprising an electric motor, the method comprising:
receiving electric power; and
filtering the received electric power to pass filtered electric power to an auxiliary device at a frequency not used for power conversion to rotational energy by the electric motor.

20. The method of claim 19, further comprising filtering electric power to the electric motor to block the electric power at the frequency not used for power conversion to rotational energy.
